(19) United States
(12) Patent Application Publication
(10) Pub. No.: US 2019/0016186 A1
(43) Pub. Date: Jan. 17, 2019

(54) WHEEL SUSPENSION FOR MOTOR VEHICLE

(71) Applicant: FORD GLOBAL TECHNOLOGIES, LLC, Dearborn, MI (US)

(72) Inventors: Ralf HINTZEN, Aachen NRW (DE); Paul ZANDBERGEN, Wuerselen NRW (DE); Nicole ZANDBERGEN, Wuerselen NRW (DE); Thomas GERHARDS, Niederzier NRW (DE)

(73) Assignee: FORD GLOBAL TECHNOLOGIES, LLC, Dearborn, MI (US)

(21) Appl. No.: 16/024,326

(22) Filed: Jun. 29, 2018

(30) Foreign Application Priority Data
Jul. 12, 2017 (DE) 10 2017 211 903.9

(51) Int. Cl. B60G 3/01; B62D 17/00; B60L 11/18

(52) U.S. Cl. CPC B60G 3/01; B60G 2200/1324; B60L 11/1877; B62D 17/00

(57) ABSTRACT

The disclosure concerns a motor vehicle with at least one rear axle having exclusively longitudinal control arms for wheel suspension. In order to create additional installation space in the region of the rear axle and at the same time improve a cornering stability of the motor vehicle, at least one vehicle component is arranged at least partially between wheel carriers of the rear axle, and at least one sliding body or rolling body is arranged on at least one wheel carrier, via which body this wheel carrier is or may be supported on the vehicle component in the vehicle transverse direction.

### CROSS-REFERENCE TO RELATED APPLICATIONS

This application claims foreign priority benefits under 35 U.S.C. § 119(a)-(d) to DE Application 10 2017 211 903.9 filed Jul. 12, 2017, which is hereby incorporated by reference in its entirety.

### TECHNICAL FIELD

The disclosure concerns a motor vehicle with at least one rear axle having exclusively longitudinal control arms for wheel suspension.

### BACKGROUND

A motor vehicle with an electric traction drive, such as for example an electric vehicle or a hybrid electric vehicle, comprises a traction battery that supplies electrical power to electric drive assemblies of the motor vehicle. Installation space for arranging the traction battery in a region of a rear axle of a motor vehicle is usually very limited. One reason for this is the space required for conventional rear axle types with longitudinal and transverse control arms, in which sufficient space must be left for movability of the control arms.

For a traction battery that is not specially configured as part of a sandwich floor of a motor vehicle, it may be necessary to sacrifice a portion of a rear luggage space of the motor vehicle for arrangement of the traction battery. Other solutions for distributing traction battery units in available spaces spread around the motor vehicle are usually cost-intensive and therefore undesirable. In particular, for safety reasons, it is preferred to use a single traction battery with a reinforced housing in which all battery cells are combined into a single secure block.

### SUMMARY

The disclosure is based on an object of creating additional installation space in a region of a rear axle of the motor vehicle, and at the same time improving a cornering stability of the motor vehicle.

According to the disclosure, the object is achieved by a motor vehicle, in which at least one vehicle component of the motor vehicle is arranged at least partially between wheel carriers of the rear axle, and at least one sliding body or rolling body is arranged on at least one-wheel carrier, via which body this wheel carrier is or may be supported on the vehicle component in a vehicle transverse direction.

It is pointed out that features and measures listed individually in the description below may be combined with each other in any technically sensible fashion and disclose further embodiments of the disclosure. The description characterizes and specifies the disclosure further, in particular in connection with the Figures.

According to the disclosure, an installation space present at a rear axle having exclusively longitudinal members may be used for partial or complete arrangement of the supporting vehicle component itself, or at least another component of the motor vehicle, for example a battery, in particular a traction battery, a gearbox, a motor or similar. Thus, it is not necessary, or only necessary to a lesser extent, to create installation space elsewhere for the vehicle component itself, or for the other component, by modification of other vehicle components. Instead, according to the disclosure, the vehicle component itself—and in some cases additionally another component—is arranged in a space present between longitudinal members and wheel carriers of the rear axle supported thereby. In this way, in particular the installation space for a traction battery in the region of the rear axle of the motor vehicle can be created according to the disclosure economically, and so as to be substantially larger than usual. For example, a traction battery can be used of a size that exceeds the installation space normally present in or on an underfloor of the motor vehicle in a tank area.

Since also at least one sliding body or rolling body is arranged on a side of one or both wheel carriers of the rear axle facing the vehicle component, via which body a respective wheel carrier is or may be supported on the vehicle component in the vehicle transverse direction, a driving stability of the motor vehicle can be improved in comparison with a motor vehicle in which the rear axle also has exclusively longitudinal control arms for wheel suspension, but these are not or cannot be supported in the vehicle transverse direction as in the present disclosure. Without support from the wheel carrier or wheel carriers in the vehicle transverse direction according to the disclosure, a rear axle only has a slight resistance against forces acting laterally, or in the vehicle transverse direction, which promotes an undesirable oversteer of the motor vehicle on cornering, i.e. a cornering stability of the motor vehicle is reduced. By supporting the wheel carrier or wheel carriers on the vehicle component in the vehicle transverse direction according to the disclosure, the cornering stability of the motor vehicle is therefore improved.

The motor vehicle according to the disclosure may be configured such that the at least one wheel carrier is supported on the vehicle component in the vehicle transverse direction without interruption, via the at least one sliding body or rolling body. Alternatively, the motor vehicle according to the disclosure may be configured such that the at least one wheel carrier is supported on the vehicle component via the at least one sliding body or rolling body only under an action of a load in the vehicle transverse direction, and on an associated elastic deformation of the longitudinal control arm connected to the wheel carrier in a direction of the vehicle component, and is not supported on the vehicle component when there is no such load action. In the latter case, the sliding body or rolling body is arranged spaced from the vehicle component when there is no lateral load action.

The sliding body may have a contact face that may be brought into or stands in physical contact with the vehicle component, and which may be configured so as to reduce friction, for example with a specific surface structuring or specific composition of material forming the contact face, which may for example comprise graphite.

The rolling body may be configured in the form of a wheel. The rolling body may be made partially or completely of a metal, a metal alloy, in particular a steel, a composite material or a plastic. The rolling body may have a running surface that stands in, or may be brought into contact, with the vehicle component, and may be formed by an elastic material, in particular an elastomer. The rolling body may roll along the vehicle component on a theoretical orbit around a front pivot point of the longitudinal control arm.

The motor vehicle may for example be a car. The motor vehicle may be an electric vehicle, a hybrid electric vehicle or a plug-in hybrid electric vehicle. The motor vehicle may comprise a traction battery that supplies electrical power to electric drive assemblies of the motor vehicle. The traction battery comprises several, in particular a plurality of battery cells that may for example be configured as lithium-ion battery cells.

According to an advantageous embodiment, the sliding body or rolling body is arranged offset towards a rear relative to a wheel rotational axis running through the wheel carrier in the vehicle transverse direction. In this way, under a load acting on the wheel carrier in the direction of the vehicle component, a flexion of the longitudinal member connected to the wheel carrier in the direction of the vehicle component may occur, whereby the wheel carrier and a wheel mounted thereon are deflected around a vertical axis so as to achieve an understeer of the motor vehicle. This improves cornering stability of the motor vehicle.

A further advantageous embodiment provides that the sliding body or rolling body is arranged offset towards the ground relative to a wheel rotational axis running through the wheel carrier in the vehicle transverse direction. In this way, under a load acting on the wheel carrier in the direction of the vehicle component, a twist of the longitudinal member connected to the wheel carrier around its longitudinal axis occurs, whereby the wheel carrier and a wheel mounted thereon are deflected around a substantially horizontal axis so as to increase a camber angle of the wheel. This improves contact between the wheel and a substrate on which the motor vehicle is travelling, and hence improves cornering stability of the motor vehicle.

It is furthermore advantageous if the sliding body or rolling body is arranged on a side of the wheel carrier facing the vehicle component. In this way, a force transmission from the wheel carrier to the vehicle component via the sliding body or rolling body is very robust, so that even high loads can be transmitted safely and without risk of failure of a connection between the wheel carrier and the sliding body or rolling body. Alternatively, the sliding body or rolling body may not be arranged on a side of the wheel carrier facing the vehicle component.

According to a further advantageous embodiment, at least two sliding bodies or rolling bodies are arranged spaced apart from each other on a side of the wheel carrier facing the vehicle component, via which bodies the wheel carrier is or may be supported on the vehicle component in the vehicle transverse direction, wherein a surface of the vehicle component coming into or standing in contact with the sliding bodies or rolling bodies is configured curved, such that contact between the sliding bodies or rolling bodies on one side and a surface on another, and/or a displacement of the sliding bodies or rolling bodies along the surface, causes a change in camber and/or tracking. On a contact between the sliding body or rolling body and a convexly or concavely curved surface of the vehicle component, the wheel carrier is force-guided on a curved surface via the at least two sliding bodies or rolling bodies in order to provoke a camber change of the wheel connected to the wheel carrier and/or a tracking change on the rear axle.

A further advantageous embodiment provides that the vehicle component is a housing of a battery, in particular a traction battery of the motor vehicle. The housing of the battery may be made partially or completely of a metal, a metal alloy, in particular a steel, a composite material, in particular a fiber composite material, or a plastic. The housing may have a symmetrical form, for example substantially cuboid.

According to a further advantageous embodiment, the housing is arranged between side longitudinal members of a chassis of the motor vehicle. In this way, the housing can be centered relative to a vehicle longitudinal central axis, and arranged positionally precisely on the motor vehicle. Also, the forces acting on the housing when a wheel carrier is supported on the housing can be absorbed well by side longitudinal members, in order to be able to make a support secure against failure and hence durable.

A further advantageous embodiment provides that at least one portion of the housing facing the wheel carrier is configured so as to be reinforced. In this way, the housing may absorb heavy loads without being destroyed when supporting a wheel carrier. To increase safety, the entire housing may also be configured so as to be reinforced.

According to a further advantageous embodiment, the vehicle component is a portion of a luggage compartment floor of the motor vehicle. In this way, luggage space of the motor vehicle on the floor side may be greatly increased. The portion of the luggage compartment floor may have a part floor lying geodetically lower than a remaining luggage compartment floor, and side walls connecting this to the remaining luggage component floor. The respective wheel carrier may be supported or be able to be supported on one of the side walls in the vehicle transverse direction via the sliding body or rolling body.

A further advantageous embodiment provides that two vehicle components are arranged at least partially between the wheel carriers and spaced apart from each other in the vehicle transverse direction, on each of which a wheel carrier is supported in the vehicle transverse direction. In this way, a space is available between the vehicle components, for example for arrangement of a battery, a gearbox or a motor. The two vehicle components may each be configured for example as a profile, for example a profiled tube or similar, connected to the vehicle floor and in some cases additionally supported in the vehicle transverse direction.

### BRIEF DESCRIPTION OF THE DRAWINGS

FIG. 1 shows a diagrammatic top view of a conventional motor vehicle, without action of a lateral load;

FIG. 2 shows a diagrammatic top view of the motor vehicle shown in FIG. 1 under action of a lateral load;

FIG. 3 a diagrammatic top view of an exemplary embodiment of a motor vehicle according to the disclosure under the action of a lateral load; and

FIG. 4 a diagrammatic rear view of the motor vehicle shown in FIG. 3.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In the various figures, the same parts always carry the same reference signs so these are usually only described once.

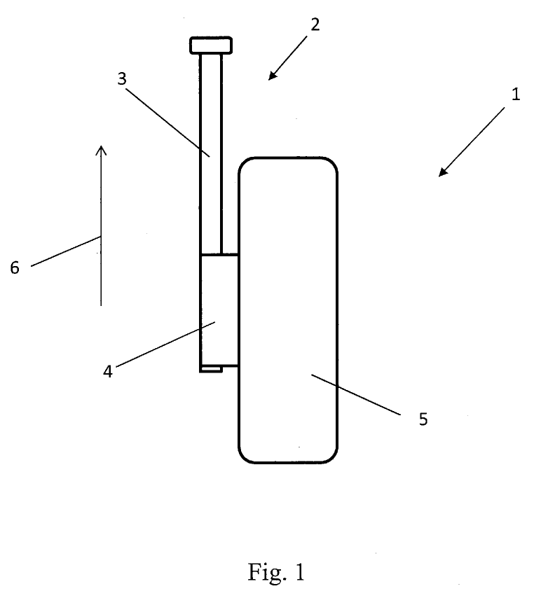

FIG. 1 shows a diagrammatic top view from above of a conventional motor vehicle 1 without an action of a lateral load. The motor vehicle 1 has a rear axle 2, of which FIG. 1 shows a single, longitudinal control arm 3, on one end region of the rear axle 2, a wheel carrier 4 is attached, and another end of the rear axle 2 is pivoted on a sprung mass (not shown) of the motor vehicle 1. A wheel 5 is rotatably mounted on the wheel carrier 4. The rear axle 2 has exclusively longitudinal control arms 3 for wheel suspension. A forward travel direction of the motor vehicle 1 is indicated by arrow 6.

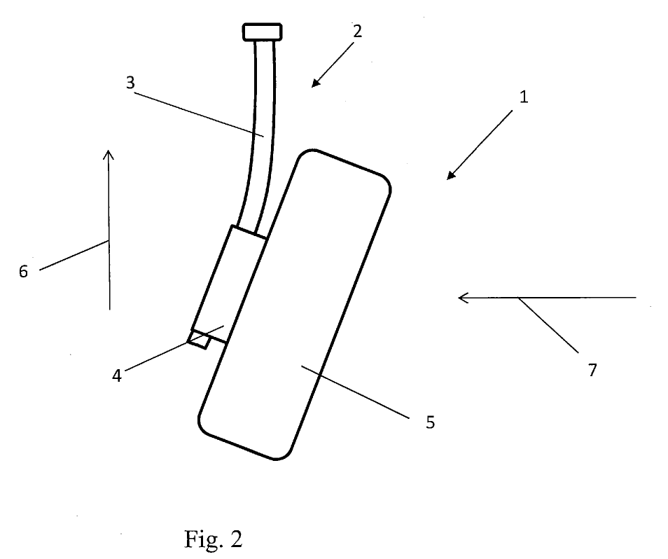

FIG. 2 shows a diagrammatic top view from above of the motor vehicle 1 shown in FIG. 1 under the action of a lateral load, or a load occurring in the vehicle transverse direction, as indicated by arrow 7. The load action may occur during travel of the motor vehicle 1, for example when the motor vehicle 1 is travelling around a left-hand bend of a road. Action of the load elastically deforms the longitudinal control arm 3. This may cause the motor vehicle 1 to oversteer, which is undesirable.

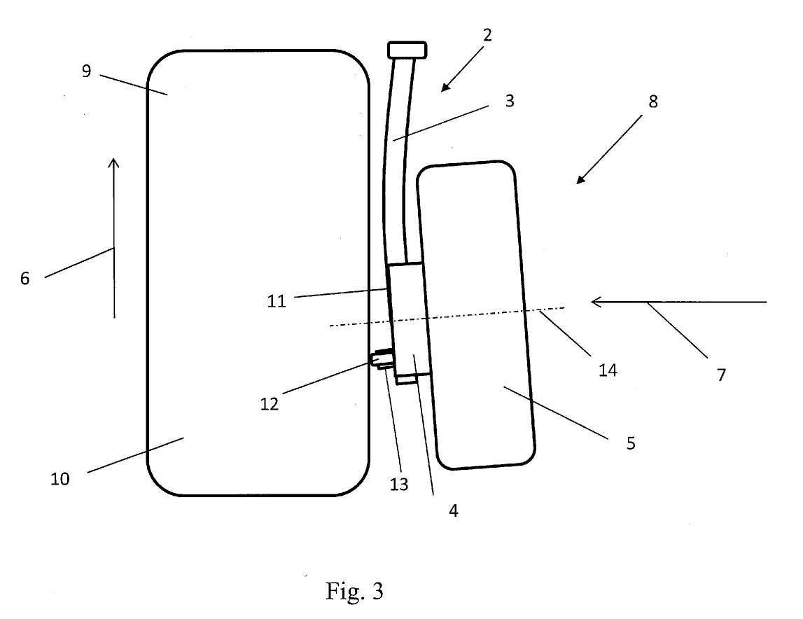

FIG. 3 shows a diagrammatic top view from above of an exemplary embodiment of a motor vehicle 8 according to the disclosure under the action of a lateral load, or a load acting in the vehicle transverse direction, as indicated by arrow 7. The motor vehicle 8 has a rear axle 2, of which a single longitudinal control arm 3 is shown in FIG. 3, on one end region of the rear axle 2 a wheel carrier 4 is attached and another end of the rear axle 2 is pivoted on a sprung mass (not shown) of the motor vehicle 8. A wheel 5 is rotatably mounted on the wheel carrier 4. The rear axle 2 has exclusively longitudinal control arms 3 for wheel suspension. The forward travel direction of the motor vehicle 8 is indicated by arrow 6.

Furthermore, the motor vehicle 8 has a battery 9 in the form of a traction battery arranged in a region of the rear axle 2. A housing 10 of the battery 9 is arranged partially between the wheel carriers 4 of the rear axle 2, wherein FIG. 3 shows only one wheel carrier 4 of the rear axle 2. The housing 10 is arranged between side longitudinal members (not shown) of a chassis (not shown) of the motor vehicle 8. At least one portion of the housing 10 facing the wheel carrier 4 shown is configured so as to be reinforced.

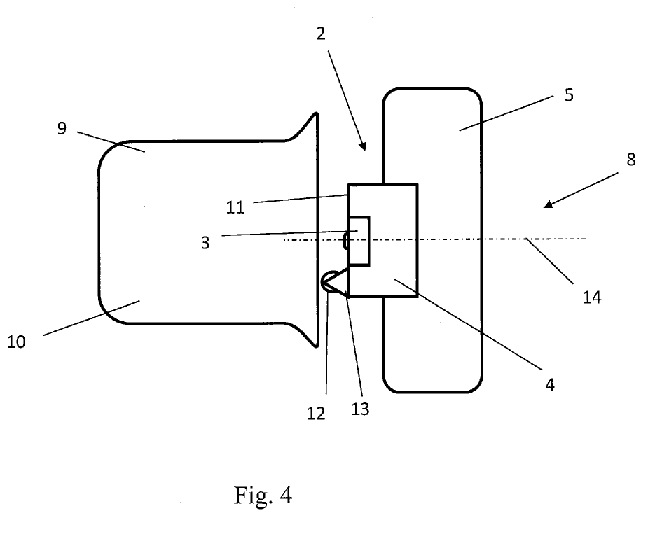

A rolling body 12 is arranged on a side 11 of each wheel carrier 4 facing the housing 10, on which body a respective wheel carrier 4 is or may be supported on the housing 10 in the vehicle transverse direction, as shown in FIG. 3. The wheel-shaped rolling body 12 is arranged so as to be rotatable on bearing knuckles 13 via radial and/or axial bearings (not shown), wherein these knuckles 13 are fixed to a side 11 of the wheel carrier 4. The rolling body 12 is offset towards a rear relative to a wheel rotational axis 14 running through the wheel carrier 4 in the vehicle transverse direction, in order to be able to achieve a tracking change under the action of the load. Also, the rolling body 12 is offset towards a ground relative to the wheel rotational axis 14 running through the wheel carrier 4 in the vehicle transverse direction, as shown in FIG. 4, in order to be able to achieve a camber change under the action of the load. Alternatively, a sliding body (not shown) may be arranged on the side 11 of the wheel carrier 4, via which body the wheel carrier 4 is or may be supported accordingly on the housing 10 in the vehicle transverse direction.

By supporting the wheel carrier 4 on the housing 10 via the rolling body 12, and by the lateral load action on the wheel 5 or wheel carrier 4, the longitudinal control arm 3 is deformed elastically (as shown in FIG. 3) or flexed in a direction of the battery 9, whereby the wheel 5 (as shown) is deflected around a vertical axis (not shown). This causes a tracking change or a desired understeer of the motor vehicle 8.

Alternatively, at least two sliding bodies or rolling bodies 12 may be arranged spaced apart from each other on the side 11 of the wheel carrier 4 facing the housing 10, via which bodies 12 the wheel carrier 4 is or may be supported on the housing 10 in the vehicle transverse direction. Here, a surface of the housing 10 coming into, or standing in, contact with the sliding bodies or rolling bodies 12 may be configured curved, such that contact between the sliding bodies or rolling bodies 12 on one side and the surface on another side, and/or a displacement of the sliding bodies or rolling bodies 12 along the surface, causes a change in camber and/or tracking.

FIG. 4 shows a diagrammatic rear view of the motor vehicle 8 shown in FIG. 3. It can be seen in particular that the rolling body 12 is arranged offset towards the ground relative to the wheel rotational axis 14 running through the wheel carrier 4 in the vehicle transverse direction. By supporting the wheel carrier 4 on the housing 10 via the rolling body 12, and under the lateral load action on the wheel 5 or wheel carrier 4, the longitudinal control arm 3 is deformed elastically or twisted about its longitudinal axis, whereby the wheel 5 is deflected about a substantially horizontal axis (not shown). This causes a camber change.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A motor vehicle comprising:
at least one rear axle having exclusively longitudinal control arms for wheel suspension, wherein at least one vehicle component is arranged at least partially between wheel carriers of the at least one rear axle; and
at least one sliding body arranged on at least one of the wheel carriers such that, via the at least one sliding body, the at least one of the wheel carriers is supported on the at least one vehicle component in a vehicle transverse direction.

2. The motor vehicle as claimed in claim 1, wherein the at least one sliding body is arranged offset towards a rear relative to a wheel rotational axis running through the wheel carrier in the vehicle transverse direction.

3. The motor vehicle as claimed in claim 1, wherein the at least one sliding body is arranged offset towards a ground relative to a wheel rotational axis running through the at least one of the wheel carriers in the vehicle transverse direction.

4. The motor vehicle as claimed in claim 1, wherein the at least one sliding body is arranged on a side of one of the wheel carriers facing the vehicle component.

5. The motor vehicle as claimed in claim 1 further comprising at least one additional sliding body that is arranged spaced apart from the at least one sliding body on a side of one of the wheel carriers facing the vehicle component such that, via the at least one additional sliding bodies, the wheel carrier facing the vehicle component is supported on the vehicle component in the vehicle transverse direction, and a surface of the vehicle component comes into contact with the at least one and additional sliding bodies being curved, wherein contact between the at least one and additional sliding bodies on one side and a surface of another side of the wheel carrier creates a displacement of the at least one and additional sliding bodies along the surface that causes a change in camber and tracking.

6. The motor vehicle as claimed in claim 1, wherein the vehicle component is a housing of a battery.

7. The motor vehicle as claimed in claim 6, wherein the housing is arranged between side longitudinal members of a chassis.

8. The motor vehicle as claimed in claim 6, wherein at least one portion of the housing that faces the at least one of the wheel carriers is reinforced.

9. The motor vehicle as claimed in claim 1, wherein the vehicle component is a portion of a luggage compartment floor.

10. The motor vehicle as claimed in claim 1 further comprising at least a second vehicle component with the at least one vehicle component being arranged at least partially between the wheel carriers and spaced apart from each other in the vehicle transverse direction, wherein on the at least one component and a second vehicle component, the at least one of the wheel carriers is supported in the vehicle transverse direction.

11. A vehicle suspension comprising:
a rear axle having exclusively longitudinal control arms for wheel suspension, wherein a housing, having a reinforced portion and being arranged between side longitudinal chassis members, for a battery is arranged between wheel carriers of the rear axle; and
a rolling body is arranged on one of the wheel carriers such that, via the rolling body, the one of the wheel carriers is supported on the battery in a vehicle transverse direction.

12. The vehicle suspension as claimed in claim 11, wherein the rolling body is arranged offset towards a rear relative to a wheel rotational axis running through the one of the wheel carriers in the vehicle transverse direction.

13. The vehicle suspension as claimed in claim 11, wherein the rolling body is arranged offset towards a ground relative to a wheel rotational axis running through the one of the wheel carriers in the vehicle transverse direction.

14. The vehicle suspension as claimed in claim 11 further comprising an additional rolling body that is arranged spaced apart from the rolling body on a wheel carrier side facing the housing such that, via the and additional rolling bodies, the one of the wheel carriers is supported on the housing in the vehicle transverse direction, wherein a surface of the housing contacts the additional rolling bodies, each sliding body being curved such that a displacement of the additional rolling bodies along the surface causes a change in camber and tracking from contact between the additional rolling bodies.

15. The vehicle suspension as claimed in claim 11 further comprising a portion of a luggage compartment of a vehicle floor with the housing being arranged at least partially between the wheel carriers, and spaced apart in the vehicle transverse direction such that, on each of the portion of the luggage compartment and the housing, the one of the wheel carriers is supported in the vehicle transverse direction.

16. A rear axle for a vehicle comprising:
exclusively longitudinal control arms for wheel suspension, wherein a housing, having a reinforced portion and being arranged between side longitudinal chassis members, for a battery is arranged between wheel carriers of a suspension; and
a sliding body is arranged on one of the wheel carriers such that, via the sliding body, the one of the wheel carriers is supported on the battery in a vehicle transverse direction.

17. The rear axle for a vehicle as claimed in claim 16, wherein the sliding body is arranged offset towards a rear relative to a wheel rotational axis running through the one of the wheel carriers in the vehicle transverse direction.

18. The rear axle for a vehicle as claimed in claim 16, wherein the sliding body is arranged offset towards a ground relative to a wheel rotational axis running through the one of the wheel carriers in the vehicle transverse direction.

19. The rear axle for a vehicle as claimed in claim 16 further comprising an additional sliding body that is arranged spaced apart from the sliding body on a wheel carrier side facing the housing such that, via the additional sliding bodies, the one of the wheel carriers is supported on the housing in the vehicle transverse direction, wherein a surface of the housing contacts the additional sliding bodies, with each sliding body being curved, such that a displacement of the additional sliding bodies along the surface causes a change in camber and tracking from contact between the additional sliding bodies.

20. The rear axle for a vehicle as claimed in claim 16 further comprising a portion of a luggage compartment of a vehicle floor with the housing being arranged at least partially between the wheel carriers, and spaced apart in the vehicle transverse direction such that, on each of the portion of the luggage compartment and the housing, the one of the wheel carriers is supported in the vehicle transverse direction.
